(19) United States
(12) Patent Application Publication
(10) Pub. No.: US 2024/0017747 A1
(43) Pub. Date: Jan. 18, 2024

(54) METHOD AND SYSTEM FOR AUGMENTING LIDAR DATA

(71) Applicant: dSPACE GmbH, Paderborn (DE)

(72) Inventors: Daniel Hasenklever, Paderborn (DE); Simon Funke, Karlsruhe (DE); Philipp Kessler, Karlsruhe (DE); Dominik Doerr, Paderborn (DE)

(21) Appl. No.: 18/251,721

(22) PCT Filed: Nov. 4, 2021
(86) PCT No.: PCT/EP2021/080610

§ 371 Date: May 4, 2023

(30) Foreign Application Priority Data
Nov. 5, 2020 (DE) 102020129158.2

(51) Int. Cl. B60W 60/00; B60W 50/00; B60W 40/107; G06V 20/58; G06V 10/82

(52) U.S. Cl. CPC B60W 60/00274; B60W 50/0098; B60W 40/107; G06V 20/58; G06V 10/82; B60W 2050/0028; B60W 2420/42; B60W 2420/52; B60W 2554/20; B60W 2554/404; B60W 2520/105

(57) ABSTRACT

A method for generating a simulation scenario includes: receiving raw data, wherein the raw data comprises a plurality of successive LIDAR point clouds, a plurality of successive camera images, and successive velocity and/or acceleration data; merging the plurality of LIDAR point clouds from a determined region into a common coordinate system to produce a composite point cloud; locating and classifying one or more static objects within the composite point cloud; generating road information based on the composite point cloud, one or more static objects and at least one camera image; locating and classifying one or more dynamic road users within the plurality of successive LIDAR point clouds and generating trajectories for the one or more dynamic road users; creating a simulation scenario based on the one or more static objects, the road information, and the generated trajectories for the one or more dynamic road users; and exporting the simulation scenario.

### CROSS-REFERENCE TO PRIOR APPLICATIONS

This application is a U.S. National Phase application under 35 U.S.C. § 371 of International Application No. PCT/EP2021/080610, filed on Nov. 4, 2021, and claims benefit to German Patent Application No. DE 10 2020 129 158.2, filed on Nov. 5, 2020. The International Application was published in German on May 12, 2022 as WO 2022/096558 A2 under PCT Article 21(2).

### FIELD

The invention relates to a computer-implemented method for generating driving scenarios based on raw LIDAR data, a computer-readable data carrier, and a computer system.

### BACKGROUND

Autonomous driving promises an unprecedented level of comfort and safety in everyday traffic. Despite enormous investments by various companies, however, existing approaches can only be used under limited conditions or enable only a subset of fully autonomous behavior. One reason for this is the lack of a sufficient number and variety of driving scenarios. For training and testing autonomous driving functions, a large number of kilometers must be covered to ensure safe operation. For example, based on real-world road tests, it is not possible to statistically prove that an autonomous vehicle is safer than a human driver in terms of fatalities.

The use of simulations can significantly increase the number of “driven” kilometers. However, modeling appropriate driving scenarios in a simulation environment is cumbersome, and replaying recorded sensor data is limited to previously encountered driving scenarios.

### SUMMARY

In an exemplary embodiment, the present invention provides a computer-implemented method for generating a simulation scenario for a vehicle. The method comprises the steps of: receiving raw data, wherein the raw data comprises a plurality of successive LIDAR point clouds, a plurality of successive camera images, and successive velocity and/or acceleration data; merging the plurality of LIDAR point clouds from a determined region into a common coordinate system to produce a composite point cloud; locating and classifying one or more static objects within the composite point cloud; generating road information based on the composite point cloud, one or more static objects and at least one camera image; locating and classifying one or more dynamic road users within the plurality of successive LIDAR point clouds and generating trajectories for the one or more dynamic road users; creating a simulation scenario based on the one or more static objects, the road information, and the generated trajectories for the one or more dynamic road users; and exporting the simulation scenario.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts an example diagram of a computer system;

FIG. 2 depicts a perspective view of an exemplary LIDAR point cloud;

FIG. 3 depicts a schematic flowchart of an embodiment of a method according to the invention for generating simulation scenarios; and

FIG. 4 depicts an example of a synthetic point cloud from a bird's eye view.

### DETAILED DESCRIPTION

Exemplary embodiments of the present invention provide improved methods for generating sensor data on driving scenarios; in particular, to easily add variations to existing driving scenarios.

In an exemplary embodiment, a computer-implemented method for generating a simulation scenario for a vehicle, in particular a land vehicle, is provided, comprising the following steps:
receiving raw data, wherein the raw data comprises a plurality of successive LIDAR point clouds, a plurality of successive camera images, and a plurality of successive velocity and/or acceleration data,
merging the plurality of LIDAR point clouds from a determined region into a common coordinate system to produce a composite point cloud,
locating and classifying one or more static objects within the composite point cloud,
generating road information based on the composite point cloud, one or more static objects and at least one camera image,
locating and classifying one or more dynamic road users within the plurality of successive LIDAR point clouds and generating trajectories for the road user(s),
creating a simulation scenario based on the one or more static objects, the road information, and the created trajectories for the one or more road users; and
exporting the simulation scenario.

A static object does not change its position in time, while the position of a road user can change dynamically. The term “dynamic road user” preferably also comprises temporary static road users such as a parked car, i.e., a road user that may be moving at a determined time but may also be stationary for a certain duration.

A simulation scenario preferably describes a continuous driving maneuver, such as an overtaking maneuver, which takes place in an environment given by road information and static objects. As a function of the behavior or the trajectories of the dynamic road users, this can be a safety-critical driving maneuver if, for example, there is a risk of collision during the overtaking maneuver due to an oncoming vehicle.

The determined region may be an area geographically defined by a range of GPS coordinates. However, it can also be an area defined by the recorded sensor data, which comprises, for example, a partial area of the surrounding area detected by the environmental sensors.

Exporting the simulation scenario may comprise saving one or more files to a data carrier and/or depositing information in a database. The files or information in the database can subsequently be read out as often as required, e.g. to generate sensor data for a virtual driving test. Thus, the existing driving scenario can be used to test different autonomous driving functions and/or to simulate different environmental sensors. It may also be intended to directly export simulated sensor data for the existing driving scenario.

A method according to the invention focuses on LIDAR data and integrates the scenario generation step, whereby the simulation scenario is not limited to fixed sensor data, but relative coordinates for the objects and road users are available. Thus, an intelligent pre-selection of interesting scenarios, but also a supplementation of existing scenarios can take place.

In a preferred embodiment of the invention, the raw data comprises synthetic sensor data generated sensor realistically in a simulation environment. Sensor data recorded from a real vehicle, synthetic sensor data, or a combination of recorded and synthetic sensor data can be used as input data for a method in accordance with the invention.

A preferred embodiment of the invention provides an end-to-end pipeline with defined interfaces for all tools and operations. This allows synergies between the different tools to be exploited, such as the use of scenario-based tests to enrich the simulation scenarios or the simulated sensor data generated from them.

In a preferred embodiment, the invention further comprises the step of modifying the simulation scenario, in particular by modifying at least one trajectory and/or adding at least one additional dynamic traffic participant, before exporting the simulation scenario. The modifications can be arbitrary or customized to achieve a desired property of a scenario. This has the advantage that by adding simulation scenarios, particularly to critical situations, sensor data can be simulated for a plurality of scenarios, thus increasing the amount of training data. Thus, it allows a user to train their models with a larger amount of relevant data, leading to improved perceptual algorithms, for example.

In a preferred embodiment, the steps of modifying the simulation scenario and exporting the simulation scenario are repeated, wherein a different modification is applied each time before exporting the simulation scenario, such that a set of simulation scenarios is assembled. The individual simulation scenarios may have metadata indicating, for example, how many pedestrians occur and/or cross the street in a simulation scenario. The metadata can be derived in particular from the localization and identification of the static objects and/or road users. In addition, information about the course of the road, such as curve parameters, or a surrounding can be added to the simulation scenario as metadata. The final data set preferably contains both the raw data and the enhanced synthetic point clouds. In a preferred embodiment, the computer used for scenario generation is connected to a database server and/or comprises a database, wherein existing simulation scenarios are stored in the database in such a manner that existing scenarios can be used to supplement the set of simulation scenarios.

In a preferred embodiment, at least one property of the set of simulation scenarios is determined, and modified simulation scenarios will be added to the set of simulation scenarios until the desired property is satisfied. The property may in particular be a minimum number of simulation scenarios that have a certain feature. For example, as a property of the set of simulation scenarios, it may be required that simulation scenarios of different types, such as inner city scenarios, highway scenarios, and/or scenarios in which predetermined objects occur, occur with at least a predetermined frequency. It can also be required as a property that a given proportion of simulation scenarios of the set lead to given traffic situations, e.g. describing an overtaking process and/or there is a risk of collision.

In a preferred embodiment, determining the property of the set of simulation scenarios comprises analyzing each modified simulation scenario using at least one neural network and/or running at least one simulation of the modified simulation scenario. For example, running the simulation can ensure that the modified simulation scenarios result in a risk of collision.

In a preferred embodiment, the property is related to at least one feature of the simulation scenarios, in particular represents a characteristic property of the statistical distribution of simulation scenarios, and the set of simulation scenarios is extended to obtain a desired statistical distribution of simulation scenarios. For example, the feature can indicate whether and/or how many objects of a given class occur in the simulation scenario. It can also be specified as a characteristic property that the set of simulation scenarios is sufficiently large to allow tests to be performed with a specified confidence. For example, a predefined number of scenarios can be provided for different classes of objects or road users to provide a sufficient amount of data for machine learning.

Preferably, the method comprises the steps of receiving a desired sensor configuration, generating simulated sensor data based on the simulation scenario as well as the desired sensor configuration, and exporting the simulated sensor data. The simulation scenarios comprise the spatial relationships of the scene and thus contain sufficient information that sensor data can be generated for any environmental sensors.

Preferably, the method further comprises the step of training a neural network for perception via the simulated sensor data and/or testing an autonomous driving function via the simulated sensor data.

In a preferred embodiment, the received raw data has a lower resolution than the simulated sensor data. By first extracting the abstract scenario from the raw data, driving situations recorded with an older, low-resolution sensor can also be reused for new systems with a higher resolution.

In a preferred embodiment, the simulated sensor data comprises a plurality of camera images. Alternatively or additionally, scenarios recorded with a LIDAR sensor can be converted into images from a camera sensor.

The invention further relates to a computer-readable data carrier containing instructions which, when executed by a processor of a computer system, cause the computer system to perform a method according to the invention.

Further, the invention relates to a computer system comprising a processor, a human-machine interface, and a non-volatile memory, wherein the non-volatile memory comprises instructions that, when executed by the processor, cause the computer system to perform a method according to the invention.

The processor may be a general-purpose microprocessor commonly used as the central processing unit of a workstation computer, or it may comprise one or more processing elements suitable for performing specific computations, such as a graphics processing unit. In alternative embodiments of the invention, the processor may be replaced or supplemented by a programmable logic device, such as a field-programmable gate array, configured to perform a specified number of operations, and/or comprise an IP core microprocessor.

The invention is explained in more detail below with reference to the drawings. In doing so, similar parts are labeled with identical designations. The embodiments shown are schematized; that is, the distances and the lateral and vertical dimensions are not to scale and, unless otherwise indicated, do not have any derivable geometric relations relative to each other.

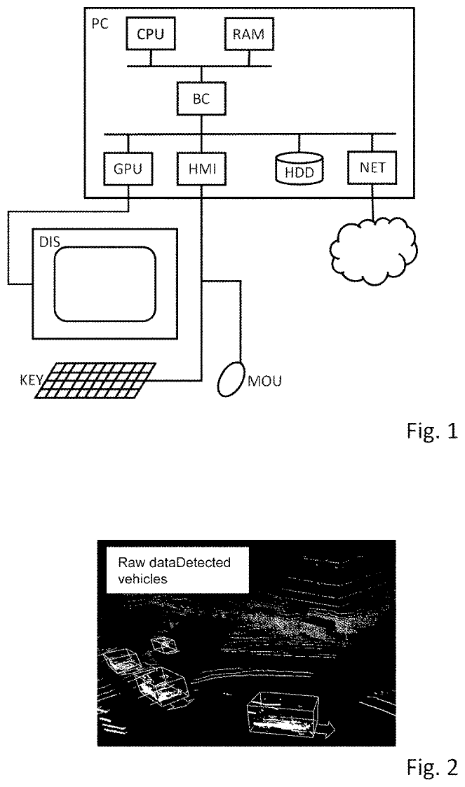

FIG. 1 shows an exemplary embodiment of a computer system.

The embodiment shown comprises a host computer PC having a monitor DIS and input devices such as a keyboard KEY and a mouse MOU.

The host computer PC comprises at least one processor CPU with one or more cores, random access memory RAM, and a number of devices connected to a local bus (such as PCI Express) that exchanges data with the CPU via a bus controller BC. The devices comprise, for example, a graphics processor GPU for driving the display, a controller USB for connecting peripheral devices, a non-volatile memory such as a hard disk or a solid-state disk, and a network interface NC. The non-volatile memory may comprise instructions that, when executed by one or more cores of the processor CPU, cause the computer system to execute a method according to the invention.

In one embodiment of the invention, indicated by a stylized cloud in the figure, the host computer may comprise one or more servers comprising one or more computing elements such as processors or FPGAs, wherein the servers are connected via a network to a client comprising a display device and input device. Thus, a method for generating simulation scenarios can be partially or fully executed on a remote server, for example in a cloud computing setup. As an alternative to a PC client, a graphical user interface of the simulation environment can be displayed on a portable computing device, particularly a tablet or smartphone.

FIG. 2 shows a perspective view of an exemplary point cloud as generated by a conventional LIDAR sensor. The raw data has already been annotated with bounding boxes around detected vehicles. On the side of objects facing the LIDAR sensor, the density of measurement points is high, while on the back side there are hardly any measurement points due to occlusion. Even more distant objects may consist of only a few points.

In addition to LIDAR sensors, vehicles often have one or more cameras, a receiver for satellite navigation signals (such as GPS), speed sensors (or wheel speed sensors), acceleration sensors, and yaw rate sensors. During the drive, these are preferably also stored, and can thus be taken into account when generating a simulation scenario. Camera data usually provide color information in addition to higher resolution, thus complementing LIDAR data or point clouds well.

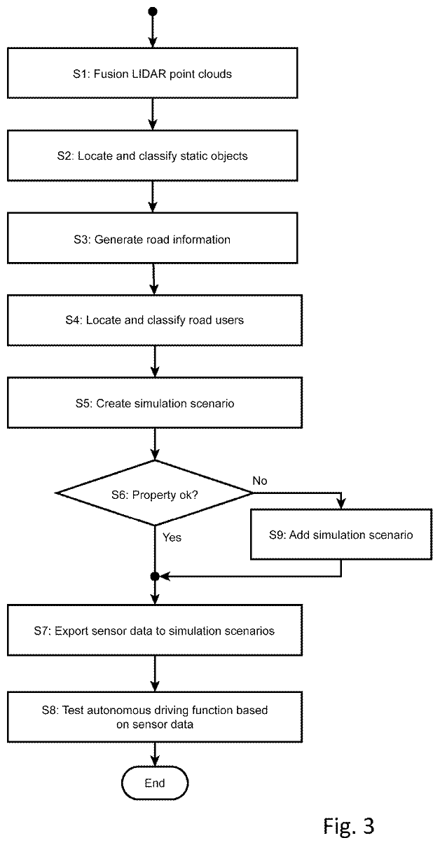

FIG. 3 shows a schematic flow chart of an embodiment of a method according to the invention for generating simulation scenarios.

Input data for scenario generation are point clouds acquired at successive points in time. Optionally, other data, such as camera data, can be used to enrich the information in the data set, e.g. if the GPS data is not accurate enough. For this purpose, algorithms known per se for simultaneous localization and mapping (“SLAM”) can be used.

In step S1 (Merge LIDAR point clouds), the LIDAR point clouds of a determined region are merged or fused in a common coordinate system.

To construct a temporally valid/consistent scene, the scans of different points in time are related to one another or the relative 3D translation and 3D rotation between the point clouds are determined. For this purpose, information such as vehicle odometry, consisting of 2D translation and yaw or 3D rotation information, as can be determined from the vehicle sensors, and satellite navigation data (GPS), consisting of 3D translation information, are used. These are complemented by lidar odometry, which provides relative 3D translations and 3D rotations using an Iterative Closest Point (ICP) algorithm. For this purpose, inherently well-known ICP algorithms can be used, such as the algorithm described in the paper “Sparse Iterative Closest Point” by Bouaziz et al. at the Eurographics Symposium on Geometry Processing 2013. This information is then fused using a graph-based optimization that weights the given information (using its covariances) and computes the resulting odometry. In the article “A Tutorial on Graph-Based SLAM” by Grisetti et al, Intelligent Transportation Systems Magazine, IEEE, 2(4):31-43, 2010, an example algorithm for graph-based optimization is described. The computed odometry can then be used to fuse the given sensor data (such as lidar, camera, etc.) into a common coordinate system. For the annotation of static objects it is useful to combine the different single image point clouds to one registered point cloud.

In step S2 (localize and classify static objects) static objects within the registered or merged point cloud are annotated, i.e. localized and identified.

Static object data contains buildings, vegetation, road infrastructure and similar. Each static object in the registered point cloud is annotated either manually, semi-automatically, automatically, or by a combination of these methods. In a preferred embodiment, static objects in the registered or merged point cloud are automatically identified and filtered via intrinsically known algorithms. In an alternative embodiment, the host computer may receive annotations from a human annotator.

The use of a registered or merged and thus dense point cloud brings many advantages in the annotation of static objects. With many more points available on an object, it is much easier to determine the correct position and size of each object. In addition, while driving, one can see an object from different angles, which gives us additional points on the object in the lidar point cloud from all directions. Overall, therefore, a much more accurate annotation of the boundaries of an object becomes possible. With a point cloud from a single viewpoint, only the points from that single viewpoint would be available for annotation. For example, when looking at an object from the front, it is difficult to determine the boundary in the back part of the object because there is no information to help estimate this boundary. In contrast, static objects are cleanly defined in the composite point cloud, which comprises receptacles from multiple viewpoints.

In step S3 (generate road information), road information is generated based on the registered point cloud and camera data.

To generate the road information, the point cloud is filtered to identify all points that describe the road surface. These points are used to estimate the so-called ground plane, which represents the ground surface for the respective LIDAR point cloud or, in the case of a registered point cloud, for the entire scene. In the next step, the color information is extracted from the images generated by one or more cameras and projected onto the ground plane using the intrinsic and extrinsic calibration information, particularly the lens focal length and viewing angle of the camera.

The road is then created using this image in plan view. First, the lane boundaries are identified and labeled. In a second step, so-called segments and crossings are identified. Segments are parts of the road network with a constant number of lanes. The next step is to merge obstacles on the road, such as traffic islands. The following step is the labeling of markers on the road. Subsequently, the individual elements are combined with the correct links to put everything together into a road model that describes the geometry and semantics of the road network for that particular scene.

In step S4 (localize and classify road users), dynamic objects or road users are annotated in the successive point clouds.

Based on their dynamic behavior, road users are annotated separately. Since road users are moving, it is not possible to use a registered or composite point cloud; rather, the annotation of dynamic objects or road users is done in single-image point clouds. Each dynamic object is annotated, i.e. localized and classified. The dynamic objects or road users in the point cloud can be cars, trucks, vans, motorcycles, cyclists, pedestrians and/or animals. In principle, the host computer can receive results of a manual or computer-assisted annotation. In a preferred embodiment, annotation is performed automatically via intrinsically known algorithms, particularly trained deep learning algorithms.

For the annotation it is useful if images of at least one camera recording parallel to the LIDAR sensor are taken into account, which must show the same objects due to temporal coincidence (assuming corresponding overlap of the viewing angles). Compared to a sparse lidar point cloud, camera images contain more information, particularly due to the higher resolution. For example, in the lidar point cloud, a distant pedestrian (>100 meters) could be represented by only a single lidar point, but be clearly visible in the camera image. It is therefore expedient to perform object recognition on the camera images via intrinsically known algorithms such as YOLO and correlation with the corresponding region of the LIDAR point cloud. Camera information is therefore very useful for identifying and classifying an object; moreover, classification based on camera information can also help determine the size of an object. Depending on the classification, predetermined standard sizes are then used or specified for the various road users. This facilitates the reproduction of such road users, which is never close enough to the detection vehicle to allow size determination from a dense point distribution on the object within the LIDAR point cloud.

After identifying and classifying the road users in the single-image LIDAR point clouds and, if available, camera images, the temporal chains for the individual objects are identified. Each road user is assigned a unique ID for all individual images, i.e. point clouds and images, in which they appear. In a preferred embodiment, the first image in which the road user appears is used to identify and classify the object, and then the corresponding field or tags are transmitted to the next images. In an alternative preferred embodiment, tracking, i.e. algorithmic tracking, of the road user takes place over successive images. Here, the detected objects are compared across multiple frames, and if the overlap of the surfaces exceeds a predefined threshold, i.e., a match is detected, they are assigned to the same road user in such a manner that the detected objects have the same ID or unique identification number. These two techniques allow the generation of consistent temporal chains over the successive camera images and LIDAR point clouds. Thus, temporal and spatial trajectories are generated for each dynamic object, which can be used to describe the behavior of the traffic participant in the simulation. Thus, dynamic objects are correlated along the time course to obtain trajectories of road users.

In step S5 (create simulation scenario), a playback scenario for a simulation environment is created from the static objects, the road information and the trajectories of the traffic participants.

Preferably, the information obtained during the annotation of the raw data in steps S2 to S4 is automatically transmitted to a simulation surrounding. The information comprises e.g. the sizes, classes, and attributes of static objects, and for traffic participants their trajectories. They are conveniently stored in a suitable file exchange format such as a JSON file; JSON here refers to the JavaScript Object Notation, a common language for specifying scenarios.

First, the information about the road contained in the JSON file is transmitted to a suitable road model of the simulation environment. This includes the geometry of the road and any semantics that were determined or introduced during annotation, for example, information about which lanes merge into which other lanes at a boundary between roadway segments or from which lane to which lane when crossing an intersection.

Subsequently, all annotated static objects are placed in the scene. For this purpose, the classification for each object including some additional attributes is read or derived from the JSON file. Based on this information, a suitable 3D object is selected from a 3D asset library and placed at the appropriate location in the scene.

Finally, the road users are placed in the scene and move them according to the annotated trajectory. For this purpose, waypoints derived from the trajectory are used and placed in the scene provided with the required temporal information. The driver models in the simulation then reproduce the behavior of the vehicle as it was recorded during the test drive.

Based on the road information, the static objects and the trajectories of the road users, a “replay scenario” is thus generated in the simulation environment. Here, all road users behave exactly as in the recorded scenario, and the replay scenario can be played back as often as desired. This enables a high reproducibility of the recorded scenarios within the simulation environment, e.g. to check new versions of driving functions for similar misbehavior as during the test drive.

In a further step, these replay scenarios are abstracted to “logical scenarios”. Logical scenarios are derived from the replay scenarios by abstracting the concrete behavior of the various road users into maneuvers in which individual parameters can be varied within specified parameter ranges for these maneuvers. Parameters of a logical scenario can be in particular relative positions, velocities, accelerations, starting points for certain behaviors like lane changes, and relationships between different objects. By deriving or inserting maneuvers with meaningful parameter ranges, it is possible to execute variations of the recorded scenarios within the simulation environment. This forms the basis for a later extension of the set of simulation scenarios.

In step S6 (property ok?), a property is determined for the existing set of one or more already created scenarios and compared with a nominal value. Depending on whether the desired property is satisfied, execution continues in step S7 or step S9.

Here, one or more features of the individual scenario can be considered, e.g., it can be required that the set comprises only those scenarios in which the required feature is present, or a characteristic property of the set can be determined from simulation scenarios such as a frequency distribution. These can be formulated into a simple or combined criterion that the data set must satisfy.

Analysis of the data set with respect to the desired specification (“delta analysis”) may comprise, but need not be limited to, questions such as: What is the distribution of the different objects in the data set? What is the target distribution of the database for the desired application? In particular, a minimum frequency of occurrence may be required for different classes of road users. This could be verified using metadata or parameters of a simulation scenario.

Usefully, the annotation of the raw data in steps S2 to S4 can already identify features that can be used in the analysis of the data set. Preferably, the raw data is analyzed using neural networks to identify the distribution of features within the real lidar point cloud. For this purpose, a number of object recognition networks, object trackers as well as attribute recognition networks are used, which automatically recognize objects within the scene and add attributes to these objects—preferably specific to the use case. Since these networks are needed anyway for the creation of the simulation scenario, there is only a small additional effort. The determined features can be stored separately and assigned to the simulation scenario. The automatically detected objects and their attributes can then be used to analyze features of the originally recorded scenario.

If the raw data already comprises a set of multiple scenarios, the properties of the raw data set can be compared to the distribution specified for the use case. These properties can comprise in particular the frequency distribution of object classes, light and weather conditions (attributes of the scene). From the comparison result, a specification for data enrichment can be determined. For example, it may be determined that certain object classes or attributes are underrepresented in the given data set and thus appropriate simulation scenarios with these objects or attributes must be added. Too low a frequency may be due to the fact that the objects or attributes under consideration occur infrequently in the particular region where the data were recorded and/or happened to occur infrequently at the time of recording.

However, when analyzing the data set, it may be required that there be a number of simulation scenarios in which a pedestrian crosses the road and/or a risk of collision occurs. Optionally, therefore, a simulation of the particular scenario can be performed to determine further specification and selection of useful data for enrichment based on scenario-based testing. As a result, a specification for enriching the data is preferably defined, indicating which scenarios are needed.

Optionally, scenario-based testing can be used to find suitable scenarios to refine the specification for data expansion. For example, if critical scenarios in inner cities are of particular interest, scenario-based testing can be used to determine scenarios with specific key performance indicators (KPIs) that meet all requirements. Accordingly, the extended data set can be limited to selected and thus relevant scenarios instead of just performing a permutation by KPIs.

If the property is not given no), in step S9 (add simulation scenario) the data set is extended by varying the simulation scenario.

In this expansion of the data set performed in step S9, which is expediently performed in the simulation environment, a user can define any statistical distribution he wishes to achieve in his expanded data set based on the automatically determined distribution within the raw data. This distribution can preferably be achieved by generating a digital twin from the existing scenario, which is at least partially annotated automatically. This digital twin can then be permuted by adding road users with a determined object class, and/or with different behavior or a modified trajectory. In the added permuted simulation scenarios, a virtual data acquisition vehicle is placed with any sensor equipment and is then used to generate new synthetic sensor data. The sensor equipment can differ in any manner from the sensor equipment used for the receptacle of the raw data. This is helpful not only to supplement existing data, but also when the sensor arrangement of the vehicle under consideration changes and the recorded scenarios serve as a basis for generating sensor data of the new/different sensor arrangement.

Within the simulation environment, the set of simulation scenarios can be extended not only by additional road users, but also by changing contrasts, weather and/or lighting conditions.

Optionally, existing scenarios from a scenario database are included in the expansion of the set of simulation scenarios; these may have been created using previously recorded raw data. Such a scenario database increases the efficiency of data extension; scenarios for different use cases can be stored in the scenario database and annotated with properties. By filtering based on the stored properties, suitable scenarios can be easily retrieved from the database.

If the property is met (yes), simulated sensor data for the simulation scenario or the complete set of simulation scenarios will be exported in step S7 (export sensor data to simulation scenarios). Here, simulated sensor data for one or more environmental sensors can be generated based on a sensor configuration such as a height above the ground and a given resolution; in addition to LIDAR data, camera images can also be generated based on the camera parameters from the simulation scenario.

In the embodiment shown, the export of simulated sensor data is performed for the entire set of scenarios; in general, each individual scenario could alternatively or supplementally be exported independently after creation. A previous export is necessary, for example, if the determination of a feature requires the simulation of the scenario.

By applying neural networks, all scenarios can be exported as simulated sensor data or sensor-realistic data. Neural networks, such as Generative Adversarial Networks (GANs), can mimic the properties of various sensors, including sensor noise. Here, the properties of the sensor originally used for the receptacle of the raw data as well as the properties of completely different sensors can be simulated. On the one hand, therefore, a scenario that largely mimics the raw data can be used for training or testing an algorithm. On the other hand, a virtual receptacle of the driving scenario can also be generated and used with various LIDAR sensors, but also with other imaging sensors such as a camera in particular.

In step S8 (test autonomous driving function using sensor data), the exported one or more scenarios, i.e., self-contained sets of simulated sensor data, are used to test an autonomous driving function. Alternatively, they can also be used to train the autonomous driving function.

The invention allows a data set of lidar sensor data to be augmented by intelligently adding data that is missing from the original data set. By exporting the additional data as realistic sensor data, it can be used directly for training and/or testing an autonomous driving function. Also, it may be intended to create or use a data set that comprises both the original raw data and the synthetic sensor data.

As a specific use case, the pipeline described above can be used to convert data from one sensor type to a synthetic point cloud of the same surrounding and with the scenario of a different sensor type. For example, data from old sensors can be converted into synthetic data representing a modern sensor. Accordingly, old sensor data can be used to extend the data of current receptacles with a new sensor type. For this use case of an output of “recycled” sensor data, a processing pipeline is preferably used, which comprises in particular the steps S1, S2, S3, S4, S5 and S7.

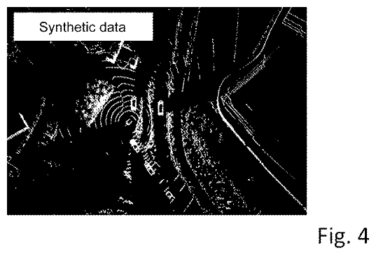

FIG. 4 shows a bird's eye view of a synthetic point cloud resulting from the export of sensor data from the simulation scenario. In the figure, individual road users are marked by bounding boxes.

A method according to the invention enables the addition of simulated sensor data to measured sensor data of a run-in scenario to varied simulation scenarios. This enables better training of perception algorithms and more comprehensive testing of autonomous driving functions.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for generating a simulation scenario for a vehicle, comprising the steps of:
receiving raw data, wherein the raw data comprises a plurality of successive LIDAR point clouds, a plurality of successive camera images, and successive velocity and/or acceleration data;
merging the plurality of LIDAR point clouds from a determined region into a common coordinate system to produce a composite point cloud;
locating and classifying one or more static objects within the composite point clouds generating road information based on the composite point cloud, one or more static objects and at least one camera image;
locating and classifying one or more dynamic road users within the plurality of successive LIDAR point clouds and generating trajectories for the one or more dynamic road users;
creating a simulation scenario based on the one or more static objects, the road information, and the generated trajectories for the one or more dynamic road users; and
exporting the simulation scenario.

2. The method according to claim 1, further comprising the step of:
modifying the simulation scenario by modifying at least one trajectory and/or adding at least one further dynamic traffic participant before exporting the simulation scenario.

3. The method according to claim 2, wherein the steps of modifying the simulation scenario and exporting the simulation scenario are repeated, and wherein a different modification is applied each time before exporting the simulation scenario, such that a set of simulation scenarios is assembled.

4. The method according to claim 3, wherein at least one property of the set of simulation scenarios is determined, and wherein modified simulation scenarios are added to the set of simulation scenarios until a desired property is satisfied.

5. The method according to claim 4, wherein determining the at least one property of the set of simulation scenarios comprises analyzing each modified simulation scenario using at least one neural network and/or running at least one simulation of the modified simulation scenario.

6. The method according to claim 4, wherein the at least one property is related to at least one feature of the simulation scenarios, and wherein the set of simulation scenarios is expanded to obtain a desired statistical distribution of the simulation scenarios.

7. The method according to claim 1, wherein exporting the simulation scenario comprises
receiving a desired sensor configuration;
generating simulated sensor data based on the simulation scenario as well as the desired sensor configuration; and
exporting the simulated sensor data.

8. The method according to claim 7, further comprising the step(s) of:
training a neural network for perception via the simulated sensor data and/or
testing an autonomous driving function via the simulated sensor data.

9. The method according to claim 7, wherein the received raw data has a lower resolution than the simulated sensor data.

10. The method according to claim 7, wherein the simulated sensor data comprises a plurality of camera images.

11. A non-transitory computer-readable medium having instructions stored thereon for generating a simulation scenario for a vehicle, wherein the instructions, when executed by a processor of a computer system, facilitate performance of the following steps by the computer system:
receiving raw data, wherein the raw data comprises a plurality of successive LIDAR point clouds, a plurality of successive camera images, and successive velocity and/or acceleration data;
merging the plurality of LIDAR point clouds from a determined region into a common coordinate system to produce a composite point cloud;
locating and classifying one or more static objects within the composite point cloud;
generating road information based on the composite point cloud, one or more static objects and at least one camera image;
locating and classifying one or more dynamic road users within the plurality of successive LIDAR point clouds and generating trajectories for the one or more dynamic road users;
creating a simulation scenario based on the one or more static objects, the road information, and the generated trajectories for the one or more dynamic road users; and
exporting the simulation scenario.

12. A computer system, comprising:
a processor;
a human-machine interface; and
non-volatile memory;
wherein the non-volatile memory comprises instructions that, when executed by the processor, facilitate performance of the following steps by the computer system:
receiving raw data, wherein the raw data comprises a plurality of successive LIDAR point clouds, a plurality of successive camera images, and successive velocity and/or acceleration data;
merging the plurality of LIDAR point clouds from a determined region into a common coordinate system to produce a composite point cloud;
locating and classifying one or more static objects within the composite point cloud;
generating road information based on the composite point cloud, one or more static objects and at least one camera image;
locating and classifying one or more dynamic road users within the plurality of successive LIDAR point clouds and generating trajectories for the one or more dynamic road users;
creating a simulation scenario based on the one or more static objects, the road information, and the generated trajectories for the one or more dynamic road users; and
exporting the simulation scenario.
